(19) United States
(12) Patent Application Publication
(10) Pub. No.: US 2012/0195704 A1
(43) Pub. Date: Aug. 2, 2012

(54) DRILL BIT

(76) Inventor: Christopher L. White, Morrison, CO (US)

(21) Appl. No.: 13/358,962

(22) Filed: Jan. 26, 2012

Related U.S. Application Data
(60) Provisional application No. 61/438,006, filed on Jan. 31, 2011.

(51) Int. Cl. B23B 51/02

(52) U.S. Cl. 408/224

(57) ABSTRACT

A drill bit for cutting successively larger holes in a substrate includes a conically-shaped body having first and second cutting flutes extending along the length of the body. The first cutting flute includes a first cutting edge and the second cutting flute includes a second cutting edge. The first and second cutting edges are offset relative to each other to create a cutting angle adapted to reduce chatter.

This application claims the benefit of Provisional Application No. 61/438,006 filed on Jan. 31, 2011.

### BACKGROUND OF THE INVENTION

The present invention relates generally to a drill bit, and more particularly to a drill bit designed to create successively larger holes in a substrate.

Having the ability to create various sized holes with a single drill bit is advantageous in that it eliminates the need to use multiple drills or to constantly change out drill bits. As a result, cone-shaped drill bits were designed. The cone-shaped drill bits include at least one cutting edge and allow the user to start with a small hole and gradually increase the diameter of the hole by increasing the depth of the drill bit within the substrate being drilled.

When a specific diameter of hole is desired, a user must be careful to control the depth of the cone-shaped drill bits so that the diameter of the hole is not made too big. This is particularly true of cone-shaped bits that have a smooth outer surface, such as that shown in FIG. 1.

As a result, drill bits, like that shown in FIG. 2, were designed to address the problems of depth and diameter. As illustrated, the drill bit includes a plurality of steps that help a user control the depth of the drill bit in a substrate. In use, a user starts the drill bit into a substrate and progresses through the steps until the desired hole diameter is achieved.

Currently, these cone-shaped drill bits are available with a single cutting flute, as shown in FIG. 3, or a pair of diametrically opposed cutting flutes, shown in FIG. 4. Both types of drill bits have their advantages and disadvantages. For example, the drill bit of FIG. 3 is known to provide a very smooth cutting operation, but unfortunately, is also very slow due to the single cutting flute. The drill bit of FIG. 4 is known to provide faster cutting performance than the drill bit of FIG. 3, but unfortunately, is known to have excessive amounts of chatter, thereby making the drill bit difficult to control. As a result, users are often forced to choose between the speed of a dual flute drill bit or the control of the single flute drill bit.

### BRIEF SUMMARY OF THE INVENTION

Accordingly, there is a need for a multi-flute, cone-shaped drill bit that provides the fast cutting performance of the dual flute drill bit and the smooth operation of the single flute drill bit.

According to one aspect of the present invention, a drill bit for cutting successively larger holes in a substrate includes a conically-shaped body having first and second cutting flutes extending along the length of the body. The first cutting flute includes a first cutting edge and the second cutting flute includes a second cutting edge. The first and second cutting edges are offset relative to each other to create a cutting angle adapted to reduce chatter.

### BRIEF DESCRIPTION OF THE DRAWINGS

The subject matter that is regarded as the invention may be best understood by reference to the following description taken in conjunction with the accompanying drawing figures in which:

FIG. 1 shows a prior art cone-shaped drill bit having a smooth outer surface;

FIG. 2 shows a prior art cone-shaped drill bit having steps on its outer surface;

FIG. 3 is a prior art single flute, cone-shaped drill bit;

FIG. 4 is a prior art dual flute, cone-shaped drill bit;

FIG. 5 shows a prior art dual flute, cone-shaped drill bit;

FIG. 6 is a top view of a multi-flute, cone-shaped drill bit according to an embodiment of the invention;

FIG. 7 is a bottom view of the multi-flute, cone-shaped drill bit of FIG. 6;

FIG. 8 is a side elevation of the multi-flute, cone-shaped drill bit of FIG. 6;

FIG. 9 is a side elevation of a multi-spiral flute, cone-shaped drill bit according to an embodiment of the invention; and

FIG. 10 is a top view of the drill bit of FIG. 9.

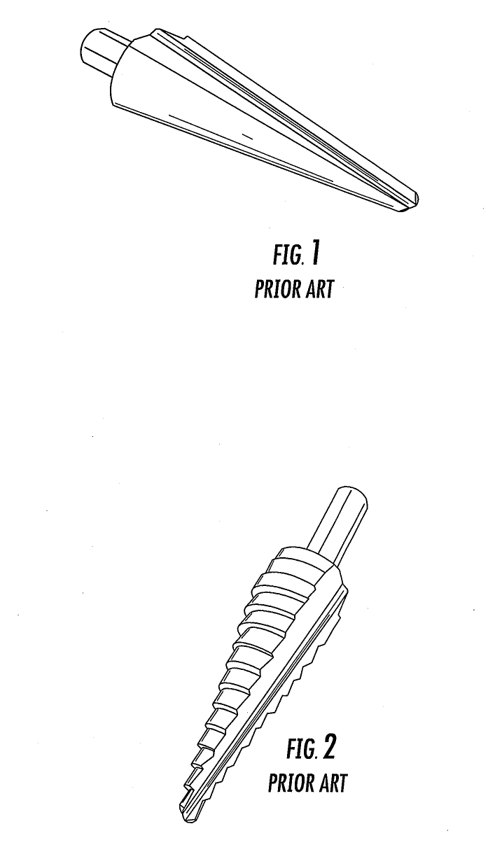

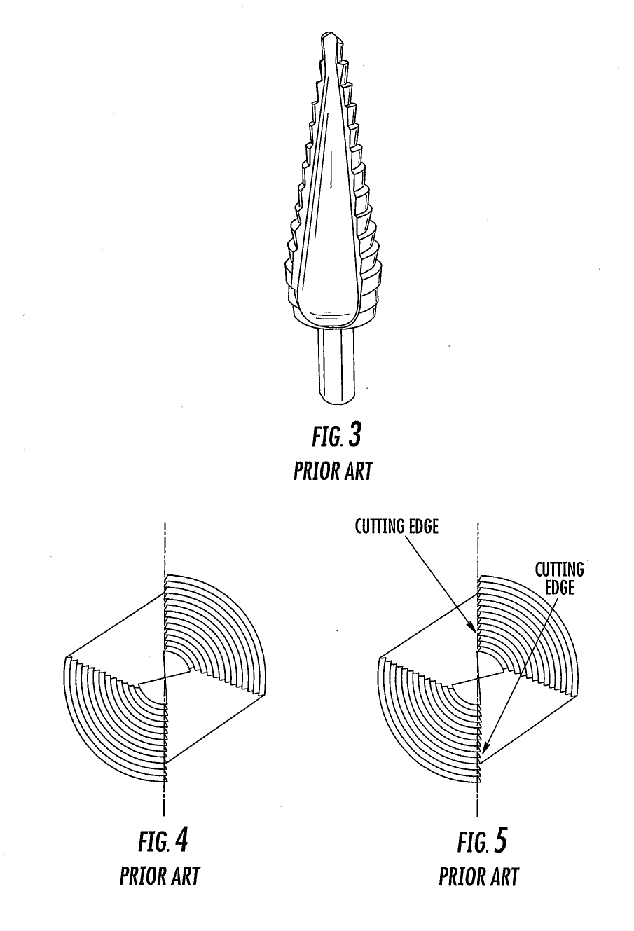

### DETAILED DESCRIPTION OF THE INVENTION

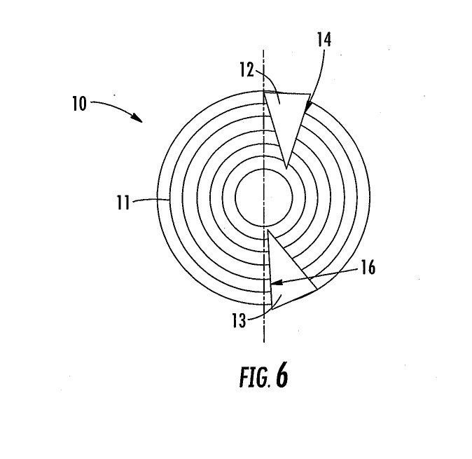

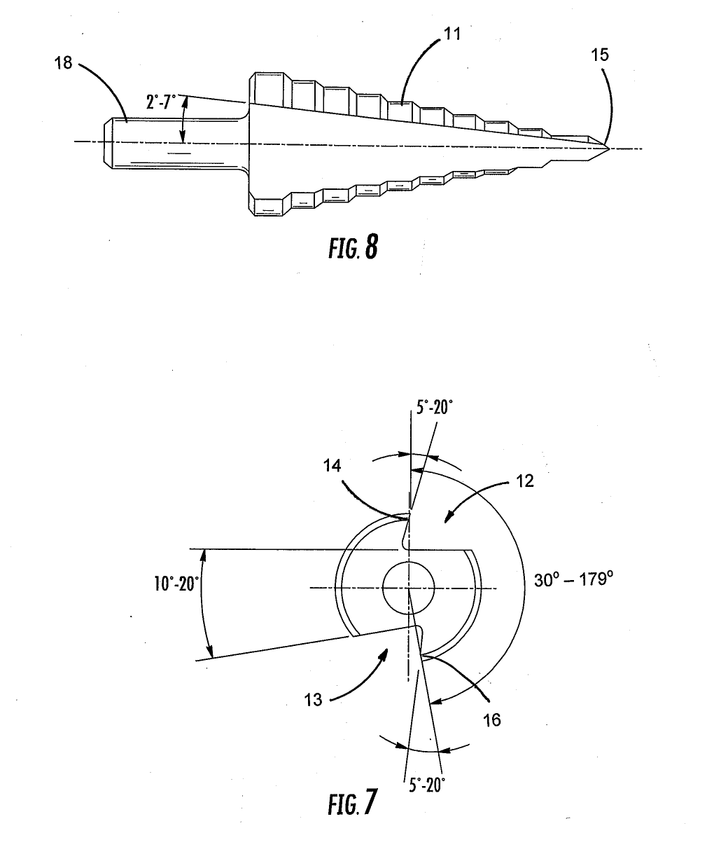

Referring to FIGS. 6-8, a multi-flute, cone-shaped drill bit according to an embodiment of the invention is shown generally at 10. As shown, the drill bit 10 includes a plurality of steps 11, increasing in diameter along the length of the drill bit 10 from the tip 15 of the drill bit 10 to the shank 18 of the drill bit 10, for controlling the depth and diameter of a hole being drilled in a substrate and a pair of cutting flutes 12 and 13, running along the length of the drill bit 10 for cutting a hole into a substrate. As shown, the flutes 12 and 13 are disposed at angles between 2 and 7 degrees off parallel to the drill bit's axis, FIG. 8. It should be appreciated that while only two cutting flutes are shown, the drill bit 10 may have additional cutting flutes. It should also be appreciated that the flutes 12 and 13 may be disposed at various angles relative to the axis of the drill bit 10. It should be appreciated that the invention works with smooth outer surface bits as well, such as those in FIG. 1.

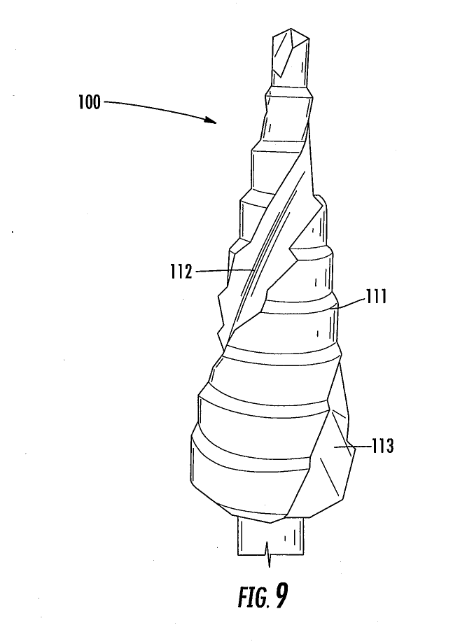

Unlike prior art cone-shaped drill bits having two cutting flutes, shown in FIG. 5, the drill bit 10 does not dispose the cutting flutes 12 and 13 in a 180 degree spaced-apart, diametrically opposed configuration, resulting in the cutting flutes being positioned on opposite sides of the drill bit. Instead, the cutting flutes 12 and 13 are disposed on the same side of the drill bit 10, as illustrated in FIGS. 6 and 7. The spacing of the cutting flutes 12 and 13 may be spaced-apart between 30 and 179 degrees, depending on the geometry of the flute—cutting edge combination. As shown in FIG. 7, the flutes 12 and 13 are spaced 160-170 degrees apart and cutting edges 14 and 16 have a cutting angle relative to center of about 5 to 20 degrees. It should be appreciated that other spacing/cutting angle combinations may be used.

It was found through testing that the diametrically opposed, 180 degree spacing caused the chatter associated with dual cutting flute drill bits. By arranging the cutting edges 14 and 16 of the flutes 12 and 13 on the same side of the drill bit in an offsetting geometry, the chattering associated with dual cutting flute drill bits could be significantly reduced or eliminated. As a result, the drill bit 10 allows a user to have the cutting performance of a dual flute drill bit and the control of a single flute drill bit.

As shown in FIG. 7, cutting edge 14 is preferably rotated 10-20 degrees relative to cutting edge 16. It should be appreciated that only one of the cutting edges may be rotated or that both cutting edges may be rotated so that an angle of 10-20 degrees is achieved between cutting edges 14 and 16. It should also be appreciated that additional rotation angles may be used to reduce chatter.

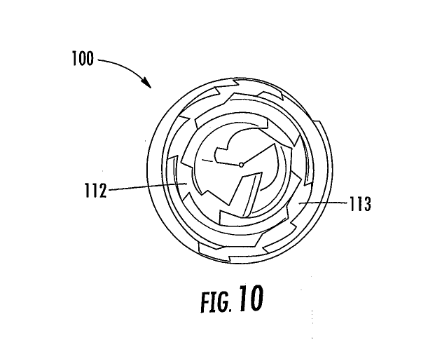

Referring to FIGS. 9 and 10, a drill bit according to an embodiment of the invention is shown generally at reference numeral 100. Like drill bit 10, drill bit 100 includes steps 111 and a pair of cutting flutes 112 and 113. The cutting flutes 112 and 113 are spiral-type flutes that wrap around the drill bit 100 as they run the length of the drill bit 100. Like drill bit 10, the flutes 112 and 113 are disposed in a spaced-apart relation on the same side of the drill bit 100 to significantly eliminate the chatter associated with dual cutting spiral flute drill bits that have a 180 degree spaced-apart, diametrically opposed configuration. The spacing of the spiral cutting flutes 112 and 113 may be spaced-apart between 30 and 179 degrees, depending on the geometry of the flute—cutting edge combination.

The foregoing has described a drill bit for creating successively larger holes in a substrate. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

I claim:

1. A drill bit for cutting successively larger holes in a substrate, comprising a conically-shaped body having first and second cutting flutes extending along the length of the body, the first cutting flute having a first cutting edge and the second cutting flute having a second cutting edge, wherein the first and second cutting edges are offset relative to each other to create a cutting angle adapted to reduce chatter.

2. The drill bit according to claim 1, wherein the first and second flutes are disposed at an angle of about two degrees off parallel to the drill bit's axis.

3. The drill bit according to claim 1, wherein the first and second flutes are disposed at an angle of about seven degrees off parallel to the drill bit's axis.

4. The drill bit according to claim 1, wherein the first and second flutes are disposed at an angle having a range of about two degrees to about seven degrees off parallel to the drill bit's axis.

5. The drill bit according to claim 1, wherein the first and second cutting flutes are spaced between about thirty degrees to about one-hundred and seventy nine degrees apart.

6. The drill bit according to claim 1, wherein the first and second cutting flutes are spaced about one-hundred and sixty degrees apart.

7. The drill bit according to claim 1, wherein the first and second cutting flutes are spaced about one-hundred and seventy degrees apart.

8. The drill bit according to claim 1, wherein the first and second cutting edges are offset to create a cutting angle relative to center of the drill bit of about five degrees to about twenty degrees.

9. The drill bit according to claim 1, wherein the first and second cutting edges are offset to create a cutting angle relative to center of the drill bit of about ten degrees.

10. The drill bit according to claim 1, wherein the first and second cutting edges are offset to create a cutting angle relative to center of the drill bit of about twenty degrees.

11. The drill bit according to claim 1 wherein the first cutting edge is rotated to create the offset.

12. The drill bit according to claim 1, wherein the second cutting edge is rotated to create the offset.

13. The drill bit according to claim 1, wherein the first and second cutting edges are rotated to create the offset.

14. The drill bit according to claim 1, wherein the flutes extend axially along the body.

15. The drill bit according to claim 1, wherein the flutes extend spirally along the body.

16. The drill bit according to claim 1, wherein the conically-shaped body has a plurality of spaced-apart steps, each of the steps extending circumferentially around the body and spaced along the length thereof and increasing in diameter from a tip of the drill bit to a shank of the drill bit.

17. The drill bit according to claim 1, wherein the conically-shaped body has a smooth outer surface that progressively increases in diameter from a tip of the drill bit to a shank of the drill bit.
